(19) United States
(12) Patent Application Publication
(10) Pub. No.: US 2015/0074110 A1
(43) Pub. Date: Mar. 12, 2015

(54) PLATFORM SYSTEM FOR OBJECT TAGGING AND METHOD THEREOF

(71) Applicants: Hoon Paek, Seongnam-si (KR); Sung Wook Yoon, Seoul (KR); Jung Ju Lee, Gyeonggi-do (KR); Won Hee Lee, Gyeonggi-do (KR); Goo Hyun Um, Seoul (KR)

(72) Inventors: Hoon Paek, Seongnam-si (KR); Sung Wook Yoon, Seoul (KR); Jung Ju Lee, Gyeonggi-do (KR); Won Hee Lee, Gyeonggi-do (KR); Goo Hyun Um, Seoul (KR)

(21) Appl. No.: 14/342,769

(22) PCT Filed: Sep. 5, 2012
(86) PCT No.: PCT/KR2012/007138

§ 371 Date: Apr. 16, 2014

(30) Foreign Application Priority Data
Sep. 5, 2011 (KR) 10-2011-0089661

(51) Int. Cl. G06F 17/30; H04L 29/08

(52) U.S. Cl. CPC G06F 17/3089; H04L 67/02
USPC 707/737

(57) ABSTRACT

The present invention relates to a platform system for object tagging and a method thereof. According to the platform system for object tagging of the present invention, since a user can add information in person, which he/she has about an individual object in contents provided by a website, into the contents of the website, as tag information, it is possible to enable an individual user to accurately, freely, and conveniently express information about an object in contents and to enable a plurality of users to actively create information and share more information by providing more users with information.

### CROSS-REFERENCE TO RELATED APPLICATION

This application claims the benefit of Korean Application No. 10-2011-0089661, filed on Sep. 5, 2011, with the Korean Intellectual Property Office, the disclosure of which is incorporated herein by reference.

### BACKGROUND OF THE INVENTION

1. Field of the Invention

The present invention relates to a platform system for object tagging and a method thereof, and more particularly to a platform system for object tagging which can promote managing of the information about objects and sharing of the information about corresponding objects among users by enabling the users to input and share desired derivative information about objects in predetermined contents on a website, regardless of the website, and a method for object tagging.

2. Description of the Related Art

Contents such as pictures, videos, and music have latent and subjective or objective information more than texts.

At present, texts are mostly used to show subjective or objective information in contents. However, contents and texts showing the internal information are independently used. For example, in common blogs, an image is posited and the objective/subjective information on the content is described in a text under the image. That is, texts and contents have a complementary relationship in terms of information transfer, but the expression ways are independent. Accordingly, an efficient expression way with texts and contents organically close to each other can increase the information transfer efficiency.

According to Korean Patent Publication No. 2010-0087561, based on the matter described above, a method of downloading selected contents from users and creating tag information on the contents from predetermined contents information, and storing it on a web server has been proposed.

The tag information is usually made in text, as described above, and convenience in management of contents is provided by creasing related tag information on the basis of the predetermined information in the contents.

However, as described above, since the method disclosed in Korean Patent Publication No. 2010-0087561 makes a user create tag information on the basis of contents information provided together with contents by a contents provider, the user cannot add various items of information that he/she knows about corresponding contents, and shares information with another user at the level of managing the contents within the range of the information provided by the contents provider or linking the URL of corresponding contents, in which the addition information that the user has about corresponding contents is simply described in text type on a specific website.

That is, there is no effective method for a user to show information that he/she has in the contents on a webpage. For example, when a user finds contents with an object associated with him/her on a website in web surfing, the user may want to show information that he/she has about the object by posting a comment. However, the user has to log in to the website in order to post a comment, but when the user is not registered on the website, it is troublesome to register on the website, so the user does not insist on posting a comment, sparing no efforts, if not necessary. If the user posted a comment through the process, it is expressed only in text type at a position not related with the object in the contents. Therefore, there is a need of a method for a user to freely and effectively express information that he/she has about the contents on a variety of websites, without registering on the websites.

At the present time, there are a great number of websites in the world and the websites have many and various types of contents such as pictures, videos, and music. Most of the contents are terminals in terms of the formation link network. That is, there is no link for the information derived from the contents. This is not because there is no derivative information in the contents, but because there is no way of effectively linking the derivative information to the contents.

Further, even if there is a way of effectively linking objective and subjective information in contents, liking information to the contents would not be so popularized, if the subject who can link information to the contents is limited, that is, only the owners of the contents or the users registered on specific websites having the contents are permitted to link information. Consequently, when a user access contents on a website that he/she just happened to visit, and hits on derivative information about an object in the contents, linking information on contents will be popularized only when the user can immediately create the derivative information and link it to an accurate position where the object exists in the contents. To this end, there is a need of a platform that supports linking of information about an object in contents, independently from the owner of the contents or the website.

### PRIOR ART DOCUMENT

### Patent Document

(Patent Document 1) Korean Patent Publication No. 2010-0087561

### SUMMARY OF THE INVENTION

In order to solve the problems described above, an object of the present invention is to provide a platform that can enable an individual user to accurately, freely, and conveniently express information about an object in contents and can promote information sharing among a plurality of users while providing more users with information, by allowing a user to add information in person, which he/she has about an individual object in contents provided by a website, into the contents of the website, as derivative information about the object in the contents.

Another object of the present invention is to provide a platform that can increase the level of security by restricting authority to receive derivative information about contents and easily preventing a user from accessing contents that requires authority.

Another object of the present invention is to allow a user to easily access a relating website from the current website without searching shopping websites about a specific object, by making it possible to add link information for connecting with a link for selling a corresponding object, as derivative information for each object in contents.

Another object of the present invention is to improve the convenience of obtaining information in accordance with the use environment, by making it possible to the type of data inputted as derivative information in accordance with user's selection for the use environment.

An embodiment of the present invention provides a platform system for object tagging which tags object in contents on a network under a browsing environment where a COT (Content base Object Tagging) client is installed. The platform system includes: a COT (Content based Object Tagging) server that receives position information about contents from the COT client and one or more items of tag information about an object in contents, matches and stores the position information and the tag information of the contents on a tag DB, and searches one or more items of tag information corresponding to the position information of the contents from the tag DB and provides the tag information to the COT client when information with the position information of the contents included but without the tag information; and a COT client that creates one or more items of information for one ore more objects in the contents in accordance with user input, transmits the tag information with the position information of the contents to the COT server, and outputs tag information for contents received from the COT server to an object in corresponding contents.

The browsing environment may be an environment based on a web browser, the contents may be included in a webpage having a predetermined URL, and the position information of the contents may be the URL of the contents.

The COT client may set authority information on tag information created in accordance with user input and transmit the authority information to the COT server.

The COT server may further receive identification information of a user from the COT client when receiving the URL of contents corresponding to tag information with authority information, search one or more items of tag information, which correspond to the URL of the contents in accordance with whether there is authority by comparing membership information stored in a membership DB corresponding to the identification information with authority information set in tag information corresponding to the URL of the contents stored in the tag DB, from the tag DB, and selectively provide the tag information to the COT client.

The COT client may receive all of items of tag information corresponding to the URL of the contents and authority information set in the tag information from the COT server, select tag information with access authority by comparing the authority information with the identification information of a user, and output the tag information on objects in the contents.

The tag information may include at least one of space-time position information, link information, text information, audio information, image information, and video information about an object in contents.

The COT server may further include an MLDB (Monetized link DB) storing link information including the URL of a shopping website relating to an object and sale information of the object and transmit link information matched with user input to the COT client by searching the MLDB on the basis of search parameters created and received by user input from the COT client, and the COT client may create the link information into tag information of the object and transmit the tag information to the COT server.

The COT client may set authority information about whether to provide the tag information in accordance with the user input, and the authority information may include at least one of member level information, one or more items of identification information, and group information including membership information.

When the authority information set in the tag information is one or more items of identification information of group information, the COT server may search a membership DB and transmits whether the tag information has been registered, using contact information individually registered for each of membership information corresponding to the identification information of the group information.

The COT server may receive tagging information about whether contents uploaded on a web server can be tagged and the URL of the uploaded contents from the COT client, match and store the tagging information and the URL on the tag DB, and the COT client may show contents on which tag information can be created in the contents included in a webpage on the basis of the received tagging information by transmitting the URL of the contents to the COT server. When receiving a plurality of items of tag information about the same object, the COT client may output the tag information in three dimensions at different positions while rotated by user input.

The COT client may calculate color information within a predetermined range where tag information is applied, and show the tag information on an object with a complementary color on the basis of the color information.

The COT client may change the data format of tag information outputted on the webpage and then output the tag information in accordance with user input, or may receive tag information with the data format changed from the COT server by transmitting user information for changing the data format to the COT server.

When a webpage uploaded on a web browser is changed, the COT client may receive tag information by transmitting the URL of contents in the changed webpage to the COT server.

The COT client may transmit at least one or more parameters, which are selected by user input from parameters of tag information outputted on an object tin contents, to the COT server, and the COT server may match the received parameters with tag information stored in the tag DB and transmit the URL of contents corresponding to one or more items of matched information to the COT client so that the URL of contents corresponding to the parameters is outputted from the COT client.

The COT client may designate an object of a specific image on the basis of user input and then sequentially track the same objects in the following images, using a predetermined method such as a motion vector estimation method using pixel changes, thereby creating tag information tagged on the same object in the video.

The COT client may provide a unit for receiving information from the COT server and directly inputting a reply on the tag information outputted on an object and update the existing tag information with the tag information having the reply and transmit the updated tag information to the COT server, and the COT server may update the tag information, which is matched with the tag information having the replay, with the tag information having the reply.

The COT client may input at leas one of text information, audio information, video information, and a video on the tag information, using a reply.

Another embodiment of the present invention provides a platform system for object tagging which communicates with a COT server managing tag information of an object in contents and installed in a user terminal to operate in combination with a web browser. The platform system includes: an authority manager that receives identification information by connecting with the COT server or transmitting log-in information and sets authority information for a right to access the tag information on the basis of user input; a tag information request unit that transmits the identification information of the authority managing unit to the COT server together with the URL of contents in a webpage loaded on the web browser, receives tag information, which is selected by comparing membership information corresponding to the identification information with tag information corresponding to the URL of the contents, from the COT server, and outputs the tag information on a corresponding object of the contents; and an editor unit that creates tag information on an object in the contents by user input, receive authority information on the created tag information from the authority managing unit, and transmits the authority information with the membership information to the COT server.

The platform system may further include a tag type converting unit that determines the data format of tag information created by the editor unit or change the data format of tag information received by the tag information request unit.

Another embodiment of the present invention provides a method for object tagging which tags an object in contents through a COT server managing tag information of the object and a COT client communicating with the COT sever and installed in a user terminal to operate in combination with a web browser. The method includes: a first step in which the COT client loaded with execution of the web browser receives identification information by connecting with the COT server or transmitting log-in information; a second step in which the COT client creates one or more items of tag information with authority information set for one or more objects in contents on a web page in accordance with user input, and transmits the identification information and the URL of the contents to the COT server; a third step in which the COT server matches one or more items of information about an object the URL of contents from the COT client and stores them on a tag DB; a fourth step in which the COT client receives tag information selected in accordance with the authority information from tag information corresponding to the URL of contents by transmitting the URL of contents with the identification information to thee COT server; and a fifth step in which the COT client outputs the tag information on a corresponding to an object in the contents.

The fourth step may include: a step in which the COT client extracts the URL of contents from a webpage loaded on the current web browser and transmits the URL with identification information to the COT server; and a step in which the COT server one or more items of tag information corresponding to the URL of contents to the COT client in accordance with whether there is authority by comparing membership information matched with the identification information with authority information set on the tag information corresponding to the URL of contents.

The firth step may further include a step in which the COT client changes the data format of the tag information on the basis of user input and outputs the tag information on an object in contents which corresponds to the URL of contents.

According to the platform system for object tagging of the present invention, since a user can add information in person, which he/she has about an individual object in contents provided by a website, into the contents of the website, as tag information, it is possible to enable an individual user to accurately, freely, and conveniently express information about an object in contents and to enable a plurality of users to actively create information and share more information by providing more users with information.

According to the present invention, since it is possible to add link properties by adding tag information for each object in contents in addition to creating the entire contents as a terminal in the related art, it is possible to contents used as a 2D-terminal into a 3D-configuration with a link and a terminal, such that it is possible to considerably increase the networking range of tags that are limited in text type in the related art.

Further, according to the present invention, since it is possible to receive tag information on contents or object in contents, it is possible to increase the level of security by easily blocking a user accessing content or tag information that require user authority.

Further, according to the present invention, since it is possible to easily access a website for selling an object from the current site including the object without a specific process of searching shopping sites for the object by creating a link that connects the website for selling the object on the basis of tag information on each object in contents, it is possible to significantly increase the frequency of using a platform supporting tag information and an advertisement effect of the sale website.

Further, according to the present invention it is possible to improve the convenience of obtaining information in accordance with the use environment, by making it possible to the data format inputted as tag information in accordance with user's selection for the use environment.

Further, according to the present invention, since it is possible to provide a user a combination of an URL relating to an object, the space-time position of the object, and various additional items of information, using the objects of tag information and related parameters for searching, it is possible to efficiently obtain information.

### BRIEF DESCRIPTION OF THE DRAWINGS

FIG. 1 is a diagram showing an operation environment of a platform system for object tagging according to the present invention.

FIG. 2 is a diagram showing the process of creating tag information in the platform system for object tagging according to the present invention.

FIG. 3 is a diagram showing an example of tagging on an individual object in contents of the platform system for object tagging according to the present invention.

FIG. 4 is a diagram showing an example of the process of outputting tag information about an object in the platform system for object tagging according to the present invention.

FIGS. 5 and 6 are diagrams showing an example of outputting tag information about an object in the platform system for object tagging according to the present invention.

FIGS. 7 and 8 are diagrams showing an example of providing tag information for authority management in the platform system for object tagging according to the present invention.

FIG. 9 is a diagram showing the process of determining whether tagging is possible on the basis of contents-proprietary right in the platform system for object tagging according to the present invention.

FIG. 10 is a diagram showing the process of tagging for linking to a shopping website in the platform system for object tagging according to the present invention.

FIG. 11 is a diagram illustrating the configuration of the platform system for object tagging according to the present invention.

### DETAILED DESCRIPTION OF THE PREFERRED EMBODIMENTS

In order to solve the problem that it is difficult to support individual tagging of objects in contents on a web page, the present invention provides a platform system for object tagging which secures traffic efficiency by operating a specific client program with a web browser and by separating tag information created by tagging the objects from a web server that provides a web page to be provided with the tag information with convenience of managing the tag information.

Further, the present invention provides a system that supports a user so that he/she can easily tag objects in contents and enables another user to easily discriminate objects associated with the tag information by accurately designating the objects indicated by the tag information in the contents so that the tag information can be shared.

Accordingly, it is possible to improve inefficiency that a user accessing tag information about contents sees a text and checks objects relating to the tag information one by one from the entire contents by adding the tag information as text information in a space separate from the space of the contents, and to increase the information learning efficiency and considerably reduce the information processing time by accurately designating an individual object in contents and directly showing the tag information about the object.

Further, in the existing systems, garbage data for explaining objects selected for texts increases because they link the entire contents, or add explanation about objects indicated by tag information in the objects of corresponding contents and link specific texts in a terminal; however, according to the present invention, it is possible to easily recognize the links of interested objects by configuring tag information designated for each of individual objects as link information.

That is, according to the present invention, it is possible to enable a user to define a subjective/objective object in various types of contents (pictures, music, video etc.) on a website and to add information that he/she has about the object into the contents in various types (text, voice, video, link) regardless of the website, it is possible to provide another user with objects defined in the contents and the information about the objects by storing the object added to the contents and the information about the object in a specific server database and searching the server database when the user access the contents on the website, and it is possible to show the object and the information together with the contents regardless of the website.

Embodiments of a platform system for object tagging according to the present invention are described hereafter with reference to the drawings with the description above.

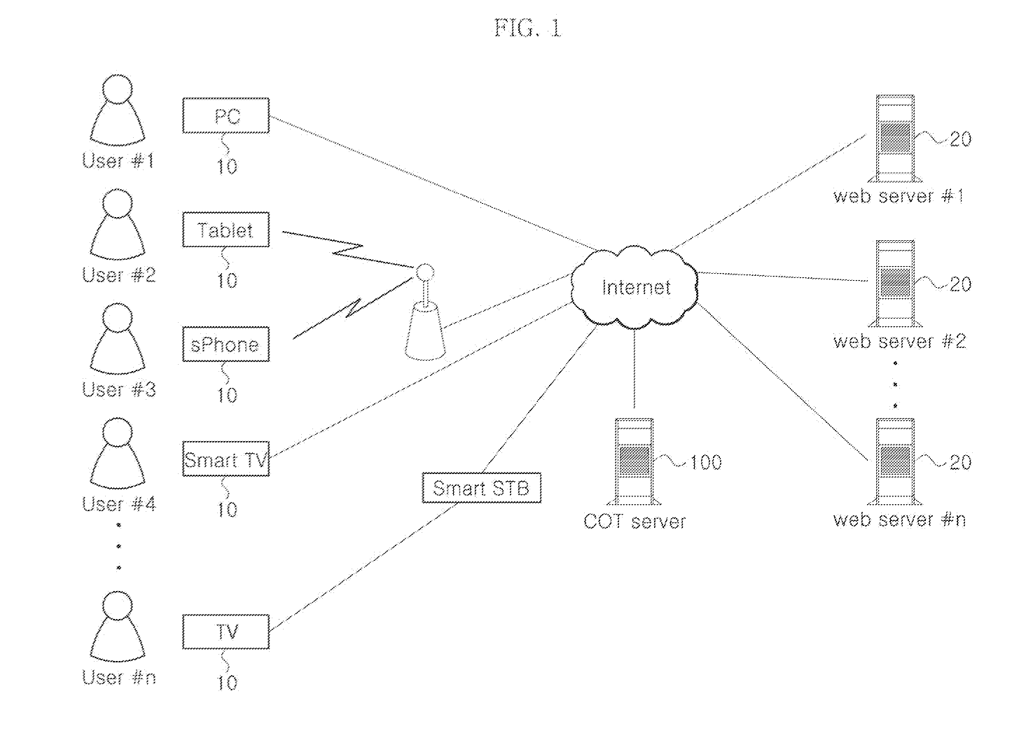

FIG. 1 shows an example of an operation environment of a platform system for object tagging according to the present invention. As shown in the figure, a user can access a plurality of different web servers 20 through a network, using a user terminal 10, and can be provided with a webpage with various contents provided by the web servers 20 through a web browser supported by the user terminal 10.

In the platform system for object tagging according to the present invention, as shown in the figure, a COT server 100 for managing tag information created by tagging objects in the contents is connected to a network separately from the web servers providing webpages, and the user terminals 10 each further include a COT client that communicates with the COT server 100 through the network, creates tag information by tagging the individual objects in the contents, and outputs the created tag information onto the individual objects in the contents in the webpages of the user terminals 10.

Accordingly, the user terminal 10 may include a PC, a tablet PC, a smart phone, a smart TV, and a TV connected through a set-top box which enable processing of tag information through the COT client, and can store tag information or output tag information related to the current loaded webpage from the COT server 100 on the webpage in communication with the COT server.

When a web browser is executed on the user terminal 10, the COT client operates and may be implemented in the type of add-on that expands the function of the web browser.

When the user terminal initially access the COT server 100, the COT server 100 can install the COT client on the user terminal 10 in the type of Active X or plug-in after determining whether there is the COT client.

When the user terminal 10 uses contents that do not support a web browser, it is possible to use the function of the COT client by installing an exclusive application program with the function of the COT client. The COT application program replaces the web browser, and the COT client may be implemented in the plug-in type of the exclusive application program or the exclusive application program and the COT client may be linked by a wrapper of the exclusive application program.

The COT server 100 can store membership information and the COT client operating in combination with the web browser can receive log-in information through user input and transmit it to the COT server 100.

Thereafter, the COT server 100 can identify the log-in information received from the COT client by comparing with the information stored in a membership DB and create communication session with the COT client when the log-in information is authenticated. Further, the COT server 100 can transmit a TID, which is user identification information in the membership information, to the COT client to identify the information sent in the communication session and the COT client can temporarily store the TID during the session and transmit it with information to be sent to the COT server 100.

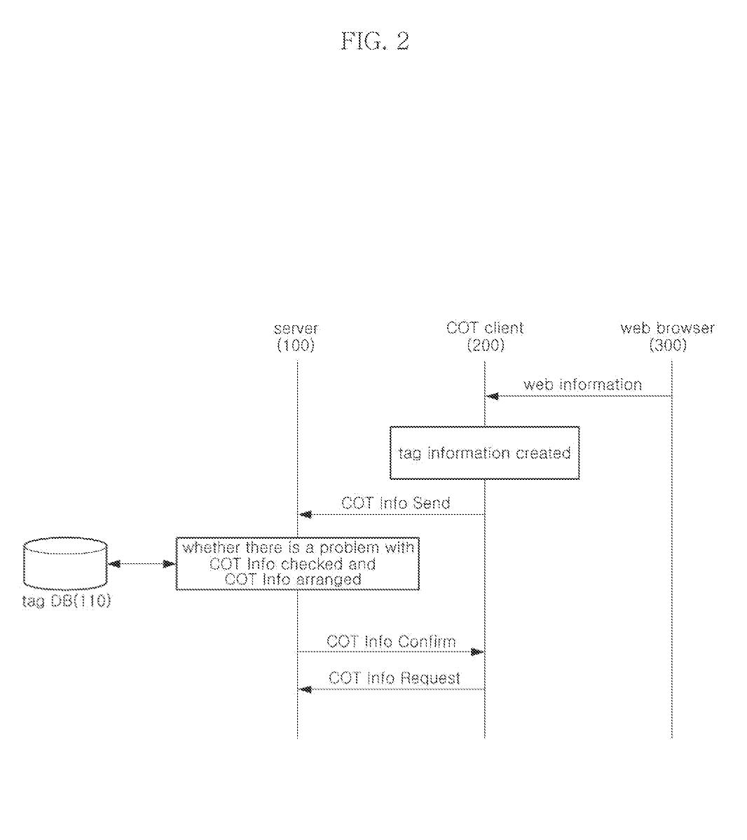

Based on the operation environment, a process of tagging objects, using the COT client and the COT server is described with reference to FIG. 2.

First, when the web browser is executed, as described above, the COT client creates session with the COT server 100 on the basis of the log-in information.

The user terminal receives contents on the web page of a specific web server by connecting with the web page through the network and the COT client 200 can create tag information by designating some of objects in the contents in response to user input.

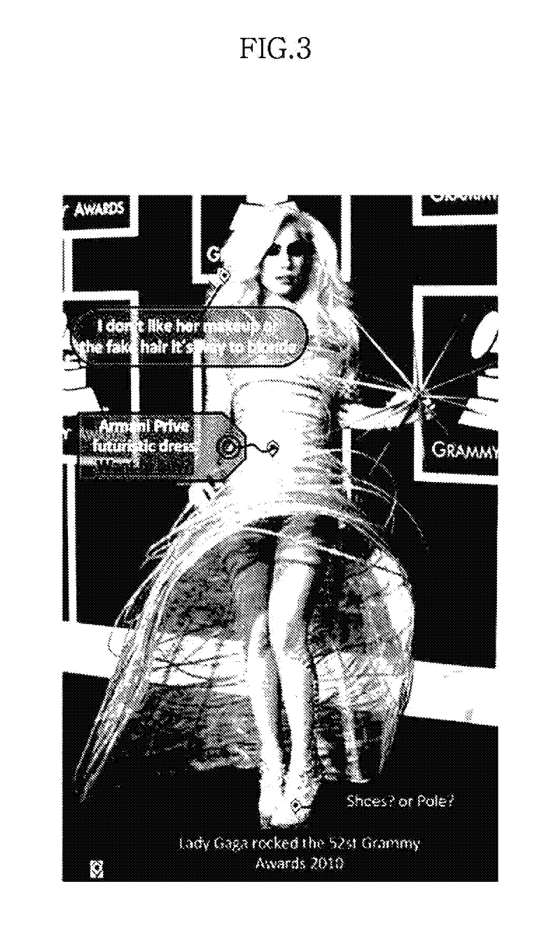

The COT client 200, as shown in FIG. 3, supports the function of inputting tag information by designating an object in the contents and the tag information can be created in the type of a container including at least one of space-time position information of the object and the information related to the object in match with the space-time position information, that is, text information, audio information, link information, image information, or video information.

Accordingly, the COT client 200, as shown in FIG. 3, can designate an individual object in the contents on the basis of the user input, input information relating to the object, and create the information as tag information.

The user who created the tag information can permit only himself/herself to see the tag information, permit specific users to see the tag information, permit users in a group that he/she specifies to see the tag information, or permit only users at a predetermined level or more from authority levels divided according to classes.

That is, to support this function, the COT client 200 can add authority information to the tag information on the basis of user input and the authority information may include the TID of the person who created the tag information, member level information, and group information to which at least one or more of TIDs or the user's TID pertains.

Accordingly, the user or another user who satisfies the authority level set in the authority information can acquire the tag information. This will be described in detail below with reference to the drawings.

The COT client 200 transmits the tag information created as described above to the COT server 100 through the connected session (COT info send: COT Information Send Protocol), and the COT client can transmit the TID and the URL of the contents including the object indicated by the tag information together with the tag information to the COT server 100.

Next, the COT server 100 receives the TID, the URL of the contents, and the tag information and checks whether there is a problem, and then it can match the URL of the contents and the tag information with each other and store it on a tag DB. The COT server can transmit the information on whether the received information has a problem or is stored, to the corresponding COT client (COT Info Confirm: COT Information Confirm Protocol). Further, the COT client can transmit a response to the information on whether the received information has a problem or is stored, to the COT server (COT Info Request COT Info Request: Protocol).

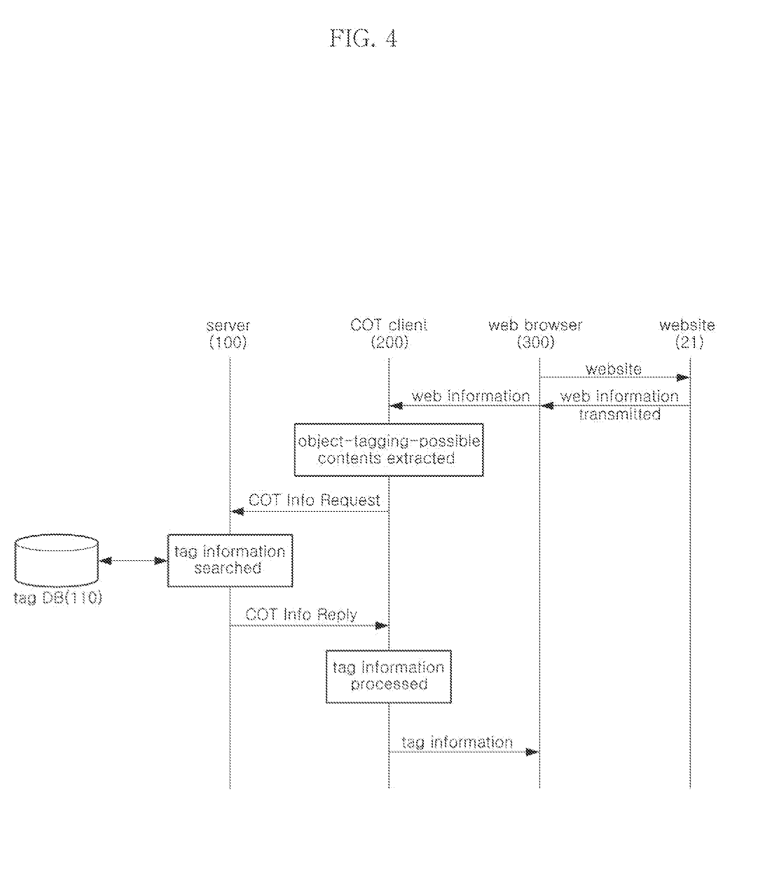

As described above, the COT server 100 collect tag information from a plurality of users and store it on the tag DB 110 through the process described with reference FIG. 2 and the COT client 200 request the COT server 100 to sent tag information in order to output the tag information stored in the COT server 100 onto the individual object in the contents on the web page (COT Info Request: COT Info Request Protocol). The process of accessing tag information in a COT server and loading it on a web page with reference to FIG. 4 is described in detail hereafter.

As described above, the COT client 200 is loaded when the web browser 300 is executed, and it can access the website 21 provided by a specific web server.

Thereafter, the COT client 200 can receive contents information provided by the website 21 and search tagging-possible contents on the basis of the contents information. For example, the COT client can determine the type of contents on a website and show tagging-possible contents except for contents such as a button of a website and advertisement of a website.

Next, the COT client 200 can transmit the URL of the tagging-possible contents to the COT server 100 and the COT server 100 can transmit corresponding tag information to the COT client by matching the URL of the contents with the tag DB (COT Info Reply: COT Information Reply Protocol).

When the authority information is set in the tag information, the COT server 100 can provide the tag information only to the COT client 200 having the TID of the user who satisfies the authority information, and it may provide the tag information to all of the COT clients 200 when there is no authority information.

Further, the COT server can transmit all of items of tag information corresponding to the URL of contents and authority information given to them to the COT client and the COT client may limit the items of tag information such that only accessible tag information is outputted on an object by comparing the TID of the current user with the authority information of received tag information. In this case, however, since the traffic rapidly increases, it is preferable that the COT server determines whether the tag information is authorized, and transmits it.

Thereafter, the COT client 200 can output the tag information onto the webpage loaded on the web browser 300. In detail, the COT client 200 can output the tag information on an individual object in the contents on the webpage.

An example of the COT client receiving user input or tag information from a COT server and shows it on an object in accordance with the processes shown in FIGS. 2 and 4 is described hereafter.

First, in order to output tag information created on the basis of user input, the COT client 200 can receive an html source of a webpage to be displayed on the web browser 300 from the web browser 300 and analyze it.

Thereafter, the COT client 200 can change the input html source in response to user input, when tagging-possible contents A exist. That is, it can change the input html source so that tag information can be outputted on the contents A and can change the input html source so that the contents A can be tagged.

Next, the COT client 200 transmits the changed html source back to the web browser 300 and the web browser 300 outputs the changed html source, the user can see the tag information that he/she tagged on the contents A.

Further, the COT client 200 can analyze an html source of a webpage from the web browser 300, extract the URL address of the contents and transmit it to the COT server 100, and receive the tag information corresponding to the transmitted URL address of the contents.

Thereafter, the COT client 200 can make the tag information be outputted on the contents A by changing the html source on the basis of the tag information and transmitting the changed html source to the web browser 300.

The COT client 200 can request the COT server 100 to sent the tag information corresponding to the contents A and output the tag information on the contents A, or can change the html source so that the tag information is outputted on the contents A under predetermined condition, for example, only a mark indicating the position of an object is outputted only when a mouse or touch point is in the range of the contents A and the tag information is outputted on the contents A only when the mark is selected by user input.

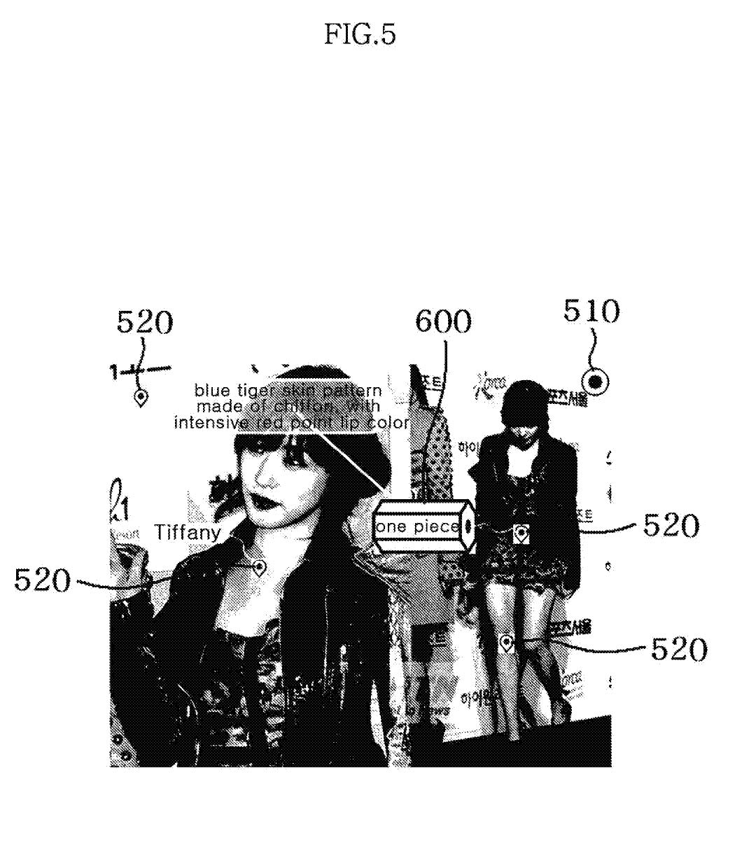

As illustrated in FIG. 5, the tag information may be outputted in various types on the contents or an object in the contents.

For example, the COT client 200 may overlay tag information on contents and may use color information about a partial image at a position to be overlaid in color determining for the tag information to increase the accessing and reading possibilities. For example, the COT client 200 can calculate partial color information at the position to be overlaid and then show the tag information, using the complementary color.

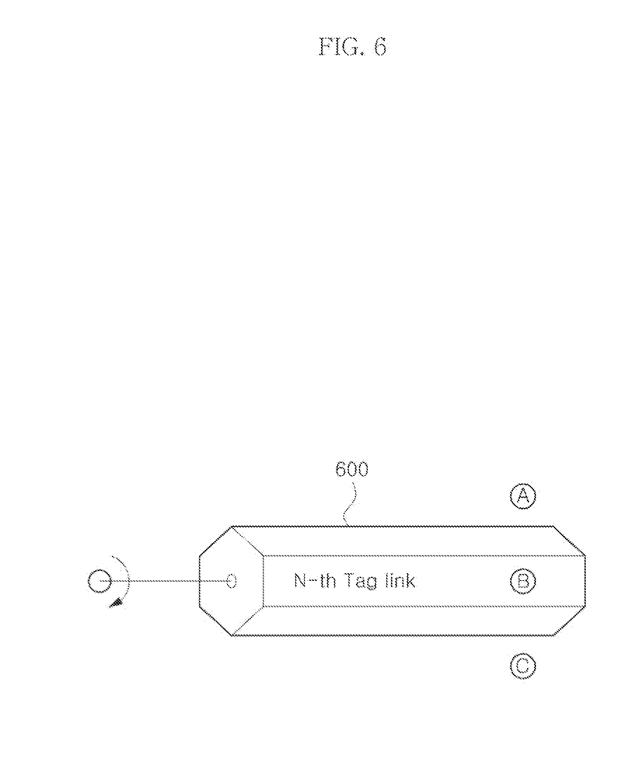

As another example, as shown in FIG. 6, when a plurality of items of tag information created by user input or a plurality of items of tag information from the COT server is outputted for one object, the COT client can use an expression method based on 3D-polygon as follows.

Accordingly, it is possible to show a plurality of items of tag information in a 3D-polygon-based container 600 and the COT client can arrange desired tag information at the front (B) by rotating the container on the basis of user input (touch input, mouse input, and keyboard input etc.).

As another example, as shown in FIG. 5, the COT client can separately show a mark 510 for showing tagging-possible contents and a mark 520 of an object having the current tag information. When mark 520 for the tagging-possible object is clicked or a pointer is moved to the mark, the COT client 200 can load a tagging tool providing tools for creating tag information. When the mark 520 for an object having the tag information is clicked or a pointer is moved to the mark 520, the COT client 200 can output tag information corresponding to the objects in the received items of tag information.

Further, the COT client can provide a unit for receiving information from the COT server and directly inputting a reply on the tag information outputted on an object. Accordingly, the COT client can update the existing tag information with the tag information having the reply and transmit it to the COT server and the COT server can update the tag information, which is matched with the tag information having the replay, with the tag information having the reply. Thereafter, the COT server can transmit the tag information having the reply to another COT client.

It is possible to input audio information, image information, and a video on the tag information by posting a comment other than the simple text information and to input different kind of information by posting a plurality of comments, when inputting the reply.

The COT client 200 can use the following method to designate an object in contents which corresponds to user input.

For example, it detects the boundary of a specific object selected from contents and extracts the object. There is no need of detecting a boundary for an abstract object.

When the designated object is an object in an image, the object is extracted with a 2D-boundary. Further, a user can construct a closed curve in person through mouse or touch input and it can be used as the boundary of an object.

Further, since a video can be considered as continuous images, a 2D-image object is extracted with a 2D-boundary and this process is individually performed on all of objects at each predetermined time.

The COT client 200 can designate an object of a specific image on the basis of user input and then sequentially track the same objects in the following images, using a predetermined method such as a motion vector estimation method using pixel changes. Accordingly, it can output tag information of a designated object in a predetermined image, for the same objects in other images.

Further, in order to select and track a specific object while a video is played, the COT client 200 can designate the object in each image by receiving user input through mouse or touch input and tracking the object while following movement of the object in response to continuous mouse or touch input.

The tag information created by the COT client 200 with the object tracking on a video can further include time information (position information in the video) and position information (coordinate information in one frame) of the frame that the object designated in the video pertains.

On the other hand, as described above, the COT client 200 can create tag information on the basis of user input. The audio information or the video information in the tag information is very useful in the mobile environment. That is, instead of using text information that a user has difficulty in inputting, under the mobile environment, the COT client 200 can easily creating tag information from audio or video information received from a microphone and a camera on a mobile device.

When receiving the audio information, the COT client 200 can create tag information by compressing the audio information with a predetermined audio codec and can transmit it to the COT server 100.

When receiving the video information, the COT client 200 can create tag information by compressing the video information with a video codec and can transmit it to the COT server 100.

Further, the COT client 200 can create the tag information in various ways in accordance with option setting by user input linked with authority information given in creation of the tag information.

That is, the COT client 200 can create at least one of the TID of the person who created tag information, membership level information, information on a group to which at least one or more TID or the user's TID pertains, as the authority information, as described above.

Further, the COT client 200 can change the option setting for outputting desired tag information in the received tag information onto the contents on the webpage 21 on the basis of user input.

Accordingly, the COT client 200 can selectively output tag information to output onto the contents on the webpage 21 by comparing the authority information set in the tag information with the option setting.

For example, when a user wants only the tag information that he/she created, the user sets his/her TID currently logged in with the option setting and the COT client outputs only the tag information having the authority information matched with the set TID.

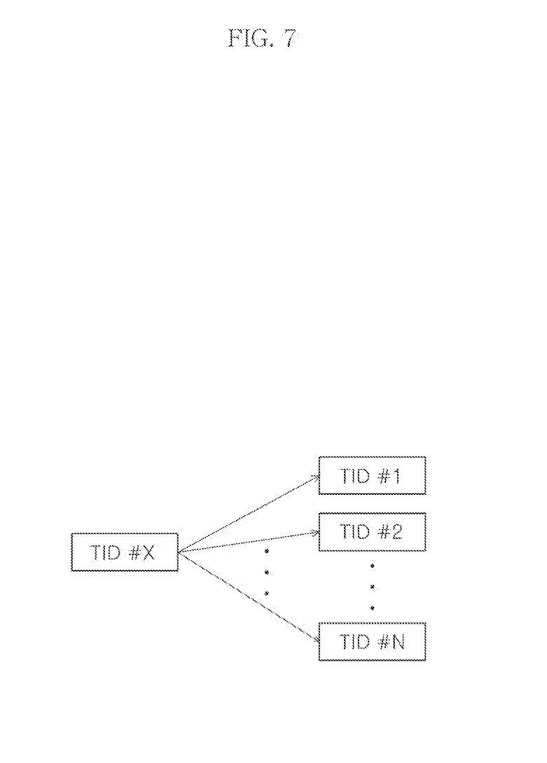

Further, as shown in FIG. 7, when the user set the option to output the tag information corresponding to the TID of another user, the COT client 200 can output only the tag information having the authority information matched with the TID of the another user.

As shown in the figure, it may be possible to output a plurality of items of tag information on the contents on the webpage by setting a plurality of other users.

Further, since the tag information having the authority information in the tag information transmitted to the COT client 200 from the COT server 100 is transmitted only to the COT client 200 that satisfies the TID set in the authority information, only the users set by the person who created the tag information can be permitted to obtain the tag information.

Further, the COT server 100 can store membership information in the membership DB by receiving the option from the COT client 200. Accordingly, when a user corresponding to the TID set in the option transmits the URL of contents and the tag information to be stored, the COT server 100 can extract the membership information with the TID set by searching the option and transmit the URL of the contents and the tag information on the E-mail or SNS addresses of members included in the membership information.

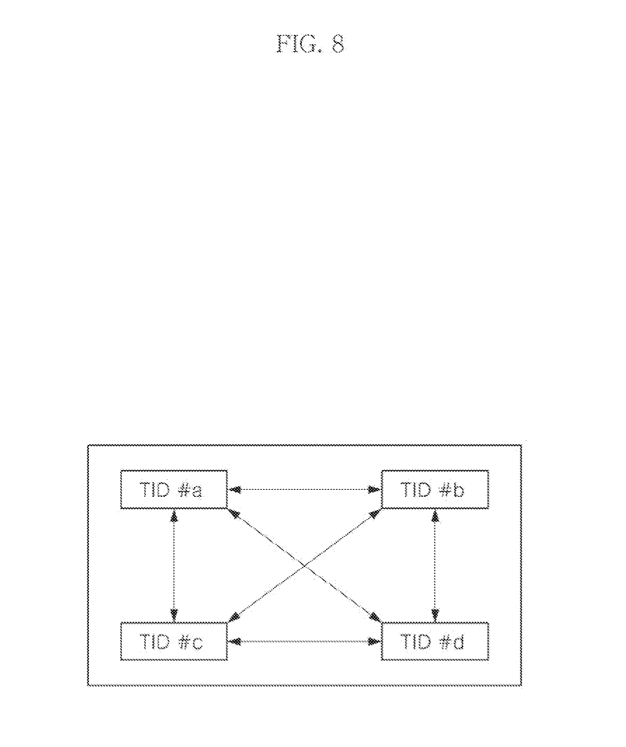

Further, as shown in FIG. 8, group information having a plurality of items of membership information may be set in the COT server 100, and accordingly, when the URL of contents created with a TID in the group information and tag information are received, the COT server 100 can search the group information that the TID pertains and transmit the URL of the contents and tag information on the E-mail or SNS addresses in the membership information in the group information.

The COT client 200 can support a user to be able to set tagging authority, when the user uploads contents on a web server. Accordingly, the user can set a limit on contents that he/she does not want to tag and the COT client 200 can determine tagging-possible contents in the webpage 21 loaded on the web browser 300.

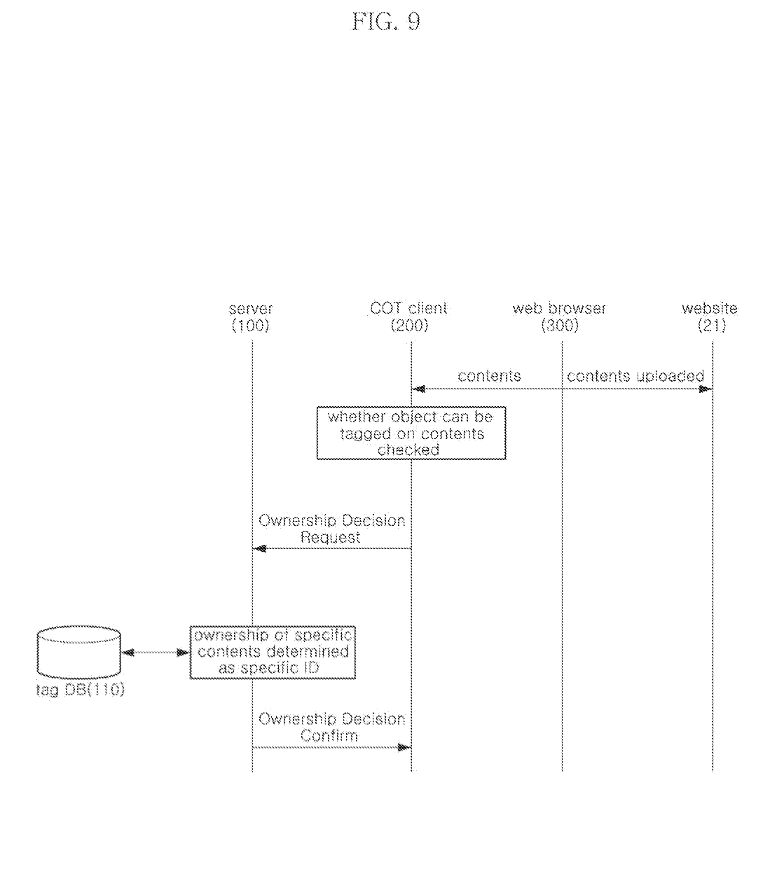

Referring to FIG. 9, when a user having membership information uploads contents on the web server 20 through the web browser 300, the COT client 200 can receive the URL of the contents and the tag-opening information from the web browser 300 by user input. The tag-opening information, which is authority information set by the owner of the contents, includes information on the opening level of the tag information to be tagged on the contents. The tag-opening information may further include website information and webpage information etc.

Thereafter, after receiving a TID corresponding to the owner of the contents and the URL of the contents and the tag-opening information from the COT client 200 (Ownership Decision Request), the COT server 100 can match the URL of the contents with the tag-opening information, determine the TID as the owner of the contents, and then store it on the tag DB 110, and it can transmit whether the TID is stored to the COT client 200 (Ownership Decision Confirm).

The COT server 100 may receive only the URL of contents and tag information and then match and store them on the tag DB 110.

Accordingly, when the owner of contents sets the opening level of tag information in the contents, the tag information created in the contents is limited by the opening level, such that the COT server can selectively provide the tag information.

For example, when the owner of the contents sets the opening level such that the tag information of corresponding contents is provided only to users set by the person who created the tag information, the COT server can selectively provide the tag information only to users set by the person who created the tag information in accordance with the limit on the tag-opening information.

Further, the COT client 200, thereafter, can obtain tagging-opening information about contents by transmitting the URL of the contents on the webpage 21 to the COT server 100 and then show matters of the opening level on the corresponding contents on the basis of the tagging-opening information.

The tag information may include link information, as described above, and the link information may be information for linking to a shopping website for selling the designated object.

In order to selectively manage the link information for linking to a shopping website, the tag DB 110 of the COT server 100 may include an OTDB (Object Tagging DB) 111 that manages common tag information and an MLDB (Monetized Link DB) 112 that manages link information for connecting with a shopping website.

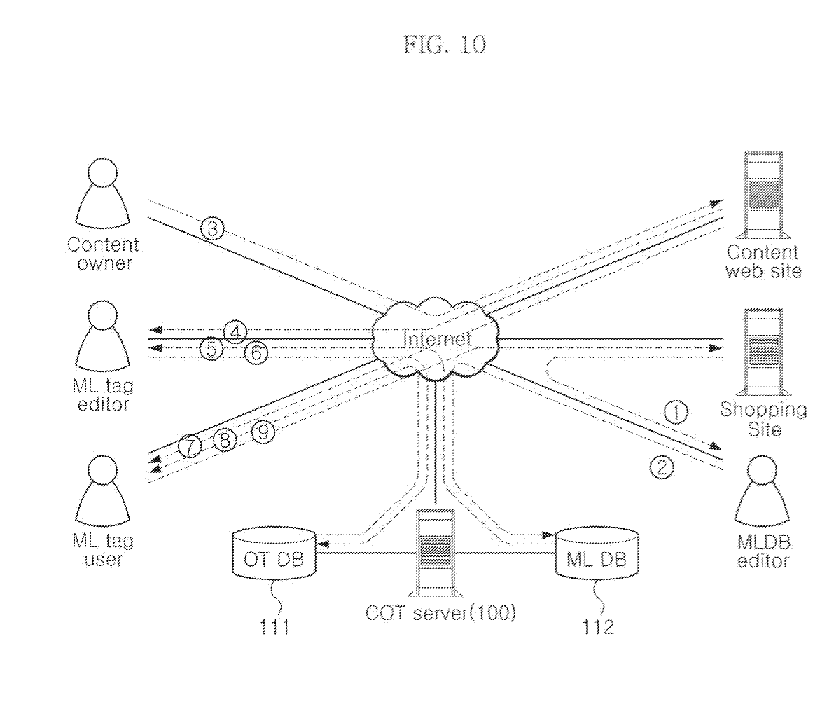

An example of the operation environment of the platform system for object tagging according to the present invention which uses the link information is described in detail with reference to FIG. 10.

A user can access a website for selling an object in contents by clicking link information tagged on the object. The user is called an ML tag user.

A user can tag link information on an object in contents without any restriction. Obviously, which one the link information is to be exposed is determined in accordance with authority information and an option, as described above.

The user is called an ML tag editor. The COT server 100 provides an MLDB for providing link information about an object to ML tag editors and the COT client 200 provides a search tool for searching link information of a specific object.

Accordingly, a user can input one or more items of sale information about an object into the MLDB 112 managed by the COT server 100 through a user terminal without any restriction. The sale information includes the product name, product specifications, product price, UPC, picture, and the URL of the shopping website for selling the object. The user who inputs sale information into the MLDB is called an MLDB editor.

The configuration shown in FIG. 10 is described on the basis of the above description. An MLDB editor finds sale information on a specific object B on a specific shopping website A (\hat{1}). Thereafter, the MLDB editor connects with the COT server 100 through a user terminal and inputs and stores the information on the object B on sale on the shopping website A onto the MLDB 112 (\hat{2}). The COT server 100 can create and store link information on the OTDB 111 on the basis of the information on the object B in the MLDB 112.

Thereafter, a content owner C uploads his/her contents D on a website C (\hat{3}). The ML tag editor finds the contents D on the website C (\hat{4}).

Accordingly, the COT client 200 can search whether there is the link information about the contents D in the MLDB 112 by connecting with the COT server 100 on the basis of user input by the ML tag editor who finds the object B in contents D, using a search tool (\hat{5}).

Thereafter, the COT client 200 obtains link information about the contents D from the MLDB 112, creates tag information about the object B, using the link information, and transmits the tag information to the COT server 100. The COT server 100 stores the created tag information on the OTDB 111.

Next, when the ML tag user finds contents D on the website C (\hat{7}), the COT client 200 receives tag information from the COT server 100 and tags it on the object B in the contents D (\hat{8}).

Thereafter, the ML tag user can automatically access the shopping website A connected to link information by selecting the link information (\hat{9}).

As described above, anybody can be an ML tag editor or an MLDB editor, and a COT server and a COT client can serve as a mediator between a seller and a purchaser of an object such as a content owner, an MLDB editor, and an ML tag editor in the process of purchasing the object using link information.

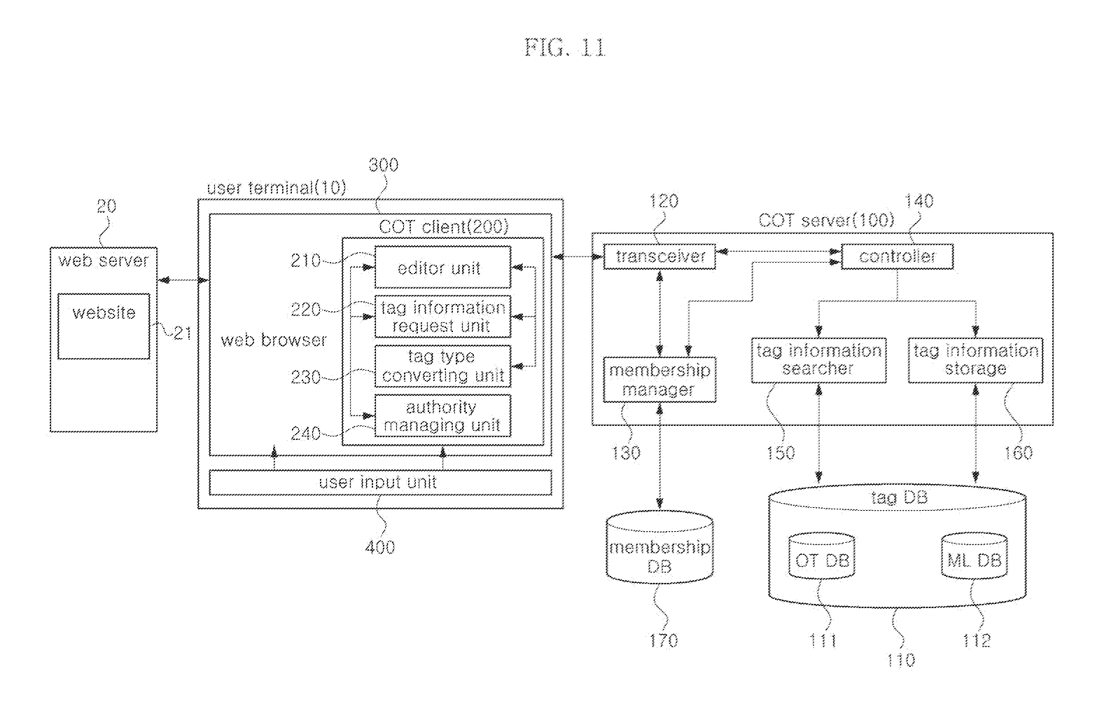

FIG. 11 is a diagram showing an example of the detailed configuration of the COT client 200 and the COT server 100 according to the present invention on the basis of the function described above. As shown in the figure, the COT client 200 is installed in the type of ActiveX or plug-in in a user terminal 10 to expand the function of the web browser 300 in combination with the web browser 300 executed in the user terminal 10, and it can operate in combination with various components in the user terminal 10.

Further, the COT server 100 communicates with the user terminal 10 through the COT client 200, manages tag information created by the COT client 200, and provide tag information that the COT client 200 requests.

The configuration of the COT client 200, in detail, may include an editor unit 210, a tag information request unit 220, a tag type converting unit 230, and an authority managing unit 240.

The authority managing unit 240 authenticates log-in information with the COT server 100, can receive and temporarily store a TID included in membership information corresponding to the log-in information until it receive log-off, can provide the TID to the editor unit 210 and the tag information request unit 220 when transmitting/receiving the tag information to/from the COT server 100, or can create authority information and provide it to the editor unit 210 in response to user input from a user input unit 400 in the user terminal 10.

Further, when contents are uploaded on a webpage 21 of the web server 20 through the web browser 300, it is possible to create the tag-opening information and provide the URL of the contents and the tag-opening information to the COT server 100.

Accordingly, when the webpage 21 having the contents is uploaded on a web browser 300 and the URL of the contents is transmitted to the COT server 100, the COT server or the COT client receiving the tag information from the COT server can output or provide tag information about the corresponding contents under certain restrictions on the basis of the tag-opening information.

When the webpage 21 is uploaded on the web browser 300, the editor unit 210 may show only the contents on which tag information can be created, by analyzing the html source of the webpage and determining whether tagging is possible in accordance with the data format of the contents (whether tag information can be created).

Further, the editor unit 210 can add a tagging tool on the function of the web browser so that tag information can be created on the basis of user input received from the user input unit 400 of the user terminal 10.

Accordingly, the editor unit 210 can add authority information and TID received from the authority managing unit 240 to the tag information created on the basis of the user input and transmit it to the COT server 100.

The editor unit 210 can receive audio information, video information, text information etc. through various input units connected with the user input unit 400 when tag information is created, and it can create compressed tag information, using a predetermined compression method according to the data format of the inputted tag information.

The tag information request unit 220 receives the URL of tagging-possible contents from the authority managing unit and transmits the URL to the COT server 100, receives tag information corresponding to the URL of the corresponding contents from the COT sever 100, and then outputs the tag information on the corresponding object in the contents.

Further, the tag type converting unit 230 can determine the way of compressing the tag information created by the editor unit 210 on the basis of user input and the way of receiving and restoring information about the data format of the tag information received by the tag information request unit 220. Accordingly, the tag type converting unit 230 can control the editor unit 210 and the tag information request unit 220 such that they operate in the determined compression and restoration ways.

Further, the tag type converting unit 230 can change the data format of tag information by controlling the editor unit 210 and the tag information request unit 220 on the basis of user input.

For example, it is efficient to create the tag information in audio or video information rather than text information in the mobile environment. Further, it is preferable to output tag information as text information rather than audio information in an environment with a limit in noise (for example, a library) when outputting the tag information on an object in contents. Further, it is useful to output audio information rather than text information, when a user cannot see other places. Further, under bad connection to the internet, it is possible to more quickly obtain information by outputting audio or text information rather than video information.

Accordingly, when the editor unit 210 creates tag information or tag information is received from the COT server 100, the tag type converting unit 230 can control the editor unit 210 and the tag information request unit 220 in accordance with conversion information about the data format of the tag information which is received through the user input unit 400.

That is, the editor unit 210 can create the tag information in accordance with the data format of any one of video information, audio information, and text information selected in accordance with the conversion information of the tag type converting unit 230.

Further, the tag information request unit 220 can analyze the data format of the received tag information, and can change the data format of tag information by converting a text into a video or a voice, or a voice into a text, or extracting and outputting a text and a voice in a video, on the basis of the conversion information from the tag type converting unit 230.

The tag information request unit 220 can use a voice composition method when changing a text into a voice and it can use a TSS or a voice recognition function when changing a voice into a text. Further, it can extract and output only a voice from video data, when changing a video into a voice.

The COT server 100, as shown in the figure, includes a transceiver 120, a membership manager 130, a tag information searcher 150, a tag information storage 160, a controller 140, a membership DB 170, and a tag DB 110.

The transceiver 120 receives log-in information, membership information, the URL of contents, a TID, tag information, and the URL of a webpage from the COT client 200 and the controller 140 controls the transceiver 120 to transmit the log-in information and membership information to the membership manager 130 and to transmit the tag information, the TID, and the URL of contents relating to tagging to the tag information searcher 150 or the tag information storage 160.

The membership manager 130 receives the membership information and stores it on the membership DB 170. When receiving the log-in information, the membership manager 130 transmits whether the log-in information is authenticated to the controller 140 after comparing the log-in information with the membership information in the membership DB, and the controller 140 can make session with the authenticated COT client 200 on the basis of the TID used in the authentication.

When the URL of contents is received without tag information in the COT client 200 corresponding to the TID, the controller 140 transmits the tag information to the tag information searcher 150 and the tag information searcher 150 searches the tag DB 110 on the basis of the URL of contents and can transmit matched tag information to the COT client 200 through the transceiver 120.

The tag information searcher 150 can determine whether to transmit the tag information by determining whether the TID transmitted with the URL of contents satisfies the TID or conditions set in authority information, by comparing the TID with the TID of the authority information or conditions in the tag information.

Further, the transceiver 120 can receive the conversion information with the URL of contents from the tag type converting unit 230 of the COT client 200 and can change the data format of the tag information corresponding to the URL of contents to be the same as in the data format conversion process according to the conversion information of the tag information request unit 220 on the basis of the conversion information, and transmit it. Accordingly, the tag information request unit 220 may immediately output tag information without a specific process of changing the data format.

Further, when both of the URL of contents and tag information are received, the controller transmit them to the tag information storage 160 and the tag information storage 160 can match the URL of contents and the tag information with each other and store in on the tag DB 110.

The tag information storage 160 can separately store link information and tag information, not the tag information through the COT client 200, in order to separately manage the link information of the shopping website described with reference to FIG. 10.

To this end, the tag DB 110 may be composed of the OTDB 111 and the MLDB 112, which were described above, the controller 140 transmits the link information of the shopping website received through the transceiver 120 to the tag information storage 160, and the tag information storage 160 can store the link information of the shopping website on the MLDB 112.

Accordingly, the editor unit 210 of the COT Client 200 can provide a search tool for searching the link information on the basis of user input and transmits user input through the search tool to the tag information searcher 150 of the COT server 100, and the tag information searcher 150 can extract link information corresponding to the input unit from the MLDB 112 and provide it to the editor unit 210.

Accordingly, the editor unit 210 creates the link information of the shopping website into tag information of a specific object and transmits it with the URL of corresponding contents, and the tag information storage 160 can match the URL of contents with tag information and store it on the OTDB 111.

On the basis of the configuration of the COT client 200 and the COT server 100, the tag information request unit 220 of the COT client 200 can provide a search tool that can search contents on the basis of tag information.

In other words, the COT client 200 can transmit a parameter selected by user input, in the parameters of the tag information relating to an object, to the COT server 100 and the COT server 100 can extract the URL of contents matched with tag information having a parameter the same as the parameter from the tag DB 110 and provide it to the COT client 200.

Thereafter, the COT client 200 can output URL of contents on a web browser.

For example, in order to see only scenes with a specific product in a specific movie, when there is tag information registered for the specific product, it is possible to extract and see only the related scenes by searching parameters relating to the specific product in the tag information. The parameters may be time information and coordinate information of tag information created from a video, as described above.

Therefore, a user can easily search pictures of videos relating to a designated object, using tag information.

What is claimed is:

1. A platform system for object tagging which tags object in contents on a network under a browsing environment where a COT (Content base Object Tagging) client is installed, the platform system comprising:
a COT (Content based Object Tagging) server that receives position information about contents from the COT client and one or more items of tag information about an object in contents, matches and stores the position information and the tag information of the contents on a tag DB, and searches one or more items of tag information corresponding to the position information of the contents from the tag DB and provides the tag information to the COT client when information with the position information of the contents included but without the tag information; and
a COT client that creates one or more items of information for one ore more objects in the contents in accordance with user input, transmits the tag information with the position information of the contents to the COT server, and outputs tag information for contents received from the COT server to a corresponding object in the contents.

2. The platform system of claim 1, wherein the browsing environment is an environment based on a web browser, the contents are included in a webpage having a predetermined URL, and the position information of the contents is the URL of the contents.

3. The platform system of claim 2, wherein the COT client sets authority information on tag information created in accordance with user input and transmits the authority information to the COT server.

4. The platform system of claim 3, wherein the COT server further receives identification information of a user from the COT client when receiving the URL of contents corresponding to tag information with authority information, searches one or more items of tag information, which correspond to the URL of the contents in accordance with whether there is authority by comparing membership information stored in a membership DB corresponding to the identification information with authority information set in tag information corresponding to the URL of the contents stored in the tag DB, from the tag DB, and selectively provides the tag information to the COT client.

5. The platform system of claim 3, wherein the COT client receives all of items of tag information corresponding to the URL of the contents and authority information set in the tag information from the COT server, selects tag information with access authority by comparing the authority information with the identification information of a user, and outputs the tag information on objects in the contents.

6. The platform system of claim 2, wherein the tag information includes at least one of space-time position information, link information, text information, audio information, image information, and video information about an object in contents.

7. The platform system of claim 2, wherein the COT server further includes an MLDB (Monetized link DB) storing link information including the URL of a shopping website relating to an object and sale information of the object and transmits link information matched with user input to the COT client by searching the MLDB on the basis of search parameters created and received by user input from the COT client, and
the COT client creates the link information into tag information of the object and transmits the tag information to the COT server.

8. The platform system of claim 2, wherein the COT client sets authority information about whether to provide the tag information in accordance with the user input, and the authority information includes at least one of member level information, one or more items of identification information, and group information including membership information.

9. The platform system of claim 8, wherein when the authority information set in the tag information is one or more items of identification information of group information, the COT server searches a membership DB and transmits whether the tag information has been registered, using contact information individually registered for each membership information corresponding to the identification information of the group information.

10. The platform system of claim 2, wherein the COT server receives tagging information about whether contents uploaded on a web server can be tagged and the URL of the uploaded contents from the COT client, matches and stores the tagging information and the URL on the tag DB, and
the COT client shows contents on which tag information can be created in the contents included in a webpage on the basis of the received tagging information by transmitting the URL of the contents to the COT server.

11. The platform system of claim 2, wherein when receiving a plurality of items of tag information about the same object, the COT client outputs the tag information in three dimension at different positions while rotated by user input.

12. The platform system of claim 2, wherein the COT client calculates color information within a predetermined range where tag information is applied, and shows the tag information on an object with a complementary color on the basis of the color information.

13. The platform system of claim 2, wherein the COT client changes the data format of tag information outputted on the webpage and then outputs the tag information in accordance with user input, or receives tag information with the data format changed from the COT server by transmitting user information for changing the data format to the COT server.

14. The platform system of claim 2, wherein when a webpage uploaded on a web browser is changed, the COT client receives tag information by transmitting the URL of contents in the changed webpage to the COT server.

15. The platform system of claim 2, wherein the COT client transmits at least one or more parameters, which are selected by user input from parameters of tag information outputted on an object tin contents, to the COT server, and
the COT server matches the received parameters with tag information stored in the tag DB and transmits the URL of contents corresponding to one or more items of matched information to the COT client so that the URL of contents corresponding to the parameters is outputted from the COT client.

16. The platform system of claim 2, wherein the COT client designates an object of a specific image on the basis of user input and then sequentially tracks the same objects in the following images, using a predetermined method such as a motion vector estimation method using pixel changes, thereby creating tag information tagged on the same object in the video.

17. The platform system of claim 2, wherein the COT client provides a unit for receiving information from the COT server and directly inputting a reply on the tag information outputted on an object and updates the existing tag information with the tag information having the reply and transmit the updated tag information to the COT server, and
the COT server updates the tag information, which is matched with the tag information having the replay, with the tag information having the reply.

18. The platform system of claim 17, wherein the COT client inputs at leas one of text information, audio information, video information, and a video on the tag information, using a reply.

19. A platform system for object tagging which communicates with a COT server managing tag information of an object in contents and installed in a user terminal to operate in combination with a web browser, the platform system comprising:
an authority manager that receives identification information by connecting with the COT server or transmitting log-in information and sets authority information for a right to access the tag information on the basis of user input;
a tag information request unit that transmits the identification information of the authority managing unit to the COT server together with the URL of contents in a webpage loaded on the web browser, receives tag information, which is selected by comparing membership information corresponding to the identification information with tag information corresponding to the URL of the contents, from the COT server, and outputs the tag information on a corresponding object of the contents; and
an editor unit that creates tag information on an object in the contents by user input, receives authority information on the created tag information from the authority managing unit, and transmits the authority information with the membership information to the COT server.

20. The platform system of claim 19, further comprising a tag type converting unit that determines the data format of tag information created by the editor unit or change the data format of tag information received by the tag information request unit.

21. A method for object tagging which tags an object in contents through a COT server managing tag information of the object and a COT client communicating with the COT sever and installed in a user terminal to operate in combination with a web browser, the method comprising:
a first step in which the COT client loaded with execution of the web browser receives identification information by connecting with the COT server or transmitting log-in information;
a second step in which the COT client creates one or more items of tag information with authority information set for one or more objects in contents on a web page in accordance with user input, and transmits the identification information and the URL of the contents to the COT server;
a third step in which the COT server matches one or more items of information about an object the URL of contents from the COT client and stores them on a tag DB;
a fourth step in which the COT client receives tag information selected in accordance with the authority information from tag information corresponding to the URL of contents by transmitting the URL of contents with the identification information to the COT server; and
a fifth step in which the COT client outputs the tag information on a corresponding to an object in the contents.

22. The method of claim 21, wherein the fourth step includes:
a step in which the COT client extracts the URL of contents from a webpage loaded on the current web browser and transmits the URL with identification information to the COT server; and
a step in which the COT server one or more items of tag information corresponding to the URL of contents to the COT client in accordance with whether there is authority by comparing membership information matched with the identification information with authority information set on the tag information corresponding to the URL of contents.

23. The method of claim 21, wherein the fifth step further includes a step in which the COT client changes the data format of the tag information on the basis of user input and outputs the tag information on an object in contents which corresponds to the URL of contents.
